(19) United States
(12) Patent Application Publication
(10) Pub. No.: US 2020/0322168 A1
(43) Pub. Date: Oct. 8, 2020

(54) PRIVACY PRESERVING IP TRACEBACK USING GROUP SIGNATURE

(71) Applicant: Agency for Science, Technology and Research, Singapore (SE)

(72) Inventors: Le Su, Singapore (SG); Dinil Mon Divakaran, Singapore (SG); Vrizlynn Ling Ling Thing, Singapore (SG)

(21) Appl. No.: 16/768,393

(22) PCT Filed: Nov. 30, 2017
(86) PCT No.: PCT/SG2017/050591

§ 371 Date: May 29, 2020

(51) Int. Cl. H04L 9/32; H04L 9/08; H04L 29/06

(52) U.S. Cl. CPC H04L 9/3255; H04L 69/22; H04L 9/3297; H04L 9/0833

(57) ABSTRACT

A method, a computer-readable medium, and an apparatus for IP traceback are provided. The apparatus may generate a group public key shared by a plurality of routers controlled by a service provider. The apparatus may generate a unique private signing key for a router of the plurality of routers. The private signing key may be used to generate a group signature for a session of network traffic. The group public key may be applied to the group signature to identify the service provider. The apparatus may identify the router by applying the group public key and a master secret key to the group signature. The apparatus may deploy preventive or mitigate action on the identified router.

### TECHNICAL FIELD

Various aspects of this disclosure generally relate to cybersecurity, and more particularly, to Internet Protocol (IP) traceback.

### BACKGROUND

Internet attacks, such as distributed denial of service (DDoS) attack, have become a growing threat to the global Internet infrastructure. In order to defend against such kind of attacks effectively, it is important to find the path as well as the source of the attack. Once the attack path is known, even if it is partial, mitigation solution (such as blocking and rate limiting) can be deployed. The challenge rises due to the fact that, the source IP addresses used in the attack are usually spoofed by the attackers in order to avoid successful identification. In view of this situation, an alternate approach is to identify the router nearest to the attacker, and subsequently deploy a preventive measurement.

The concept of IP traceback provides a tracing mechanism for victims (as well as law enforcement agencies) to reconstruct the packet routing path, possibly identify the attack origin, and subsequently enable forensic investigation. IP traceback is useful for attack deterrence, attack mitigation and forensic investigation. IP traceback also finds use in traffic path validation, bottleneck identification, and fault diagnosis.

While traceback solutions have matured over the years, there is no existing solution that has been ubiquitously deployed across the Internet, due to multiple reasons. One category of solutions, called logging-based traceback, stores packet specific information on intermediate routers or a designated storage server. This approach faces scalability issues. On the other hand, marking-based solutions, by embedding some router specific information in the packet and transmitted along the routing path, leak sensitive private information of ISP (Internet Service Provider) networks. Attackers (and possibly, competitors) can extract topology information of ISPs by sending a few traffic flows across different paths. Information leak is of major concern to ISPs, as they can lead to attacks, loss of revenue (if competitors can manipulate path selection of an ISP network), etc. In this context, a privacy preserving traceback technique, which protects sensitive information, such as router identity and network topology, may be desirable for ISPs to deploy traceback solutions in their networks.

### SUMMARY

The following presents a simplified summary in order to provide a basic understanding of various aspects of the disclosed invention. This summary is not an extensive overview of all contemplated aspects, and is intended to neither identify key or critical elements of all aspects nor delineate the scope of any or all aspects. The sole purpose is to present some concepts of one or more aspects in a simplified form as a prelude to the more detailed description that is presented later.

In one aspect of the disclosure, an IP traceback solution is provided. The IP traceback solution may not leak ISP topology related information, even to a trusted authority, while still achieving secure and deterministic trackback. With the IP traceback solution, the ISP or the marking router may not be able to deny that it produced the mark. Further, there is minimum interaction for marking generation in the IP traceback solution. The marking procedure may not involve communication between different entities in an ISP network. A non-interactive marking generation process may greatly reduce the system delay.

In one aspect of the disclosure, a method, a computer-readable medium, and an apparatus for IP traceback are provided. The apparatus may generate a group public key shared by a plurality of routers controlled by a service provider. The apparatus may generate a unique private signing key for a router of the plurality of routers. The private signing key may be used to generate a group signature for a session of network traffic. The group public key may be applied to the group signature to identify the service provider. The apparatus may identify the router by applying the group public key and a master secret key to the group signature. The apparatus may deploy preventive or mitigate action on the router.

To the accomplishment of the foregoing and related ends, the aspects disclosed include the features hereinafter fully described and particularly pointed out in the claims. The following description and the annexed drawings set forth in detail illustrate certain features of the aspects of the disclosure. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of an overall system architecture of an IP traceback solution in accordance with one embodiment of the disclosure.

FIG. 2 is a diagram illustrating an example of the setup process for the IP traceback solution described above in FIG. 1.

FIG. 3 is a diagram illustrating an example of the marking process involved in the IP traceback solution.

FIG. 4 is a diagram illustrating an example of the overall process for a trusted authority to verify signatures and identify a corresponding ISP.

FIG. 5 is a diagram illustrating an example of the tracing operation performed by an ISP.

FIG. 6 is a diagram illustrating an example of the format of a signature packet.

FIG. 7 is a diagram illustrating an example of the storage for the pre-computed values.

FIG. 8 is a flowchart of a method of IP traceback.

FIG. 9 is a conceptual data flow diagram illustrating the data flow between different means/components in an exemplary apparatus.

FIG. 10 is a diagram illustrating an example of a hardware implementation for an apparatus employing a processing system.

### DETAILED DESCRIPTION

The detailed description set forth below in connection with the appended drawings is intended as a description of various possible configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of IP traceback will now be presented with reference to various apparatus and methods. The apparatus and methods will be described in the fnllnwinQ detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media may include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

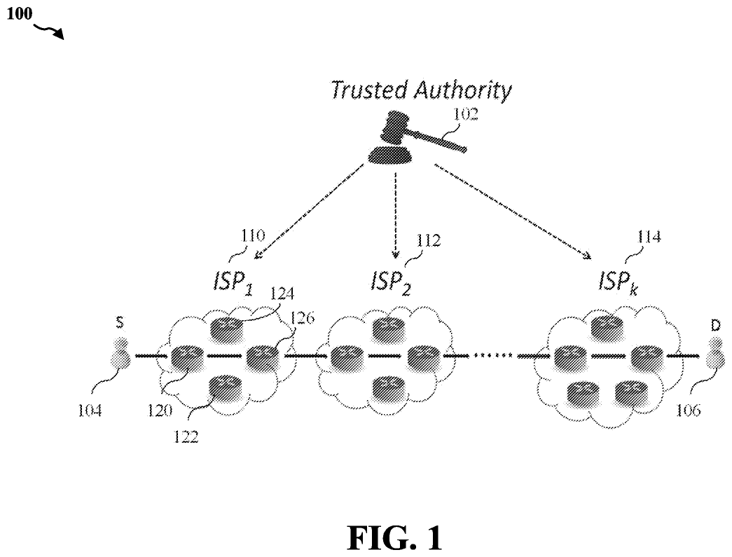

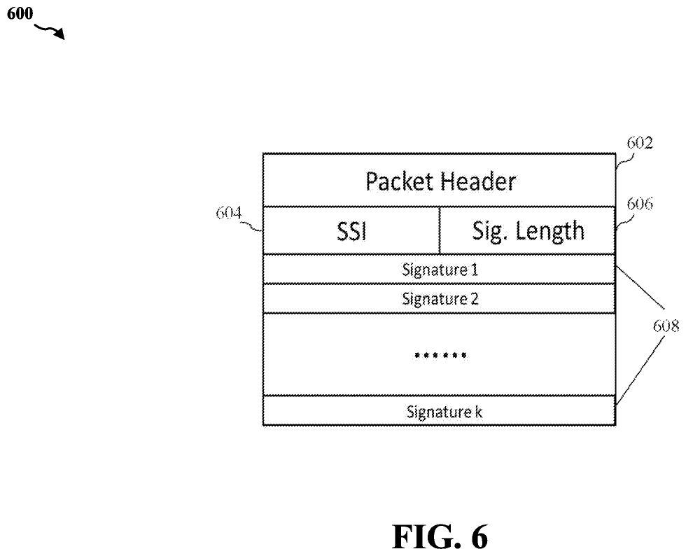

FIG. 1 is a diagram 100 illustrating an example of an overall system architecture of an IP traceback solution in accordance with one embodiment of the disclosure. In the example, the IP traceback solution may have a three-tier system architecture: a trusted authority (TA) 102, a set of Internet service providers (ISP) (e.g., ISP 110, 112, 114), and a set of routers controlled by each ISP (e.g., routers 120, 122, 124, 126 controlled by the ISP 110). The trusted authority 102 may take responsibility of identifying the ISPs from the evidences presented by users. The trusted authority 102 may also serve as a coordinator among the ISPs during dispute. Each ISP controls a set of routers. These routers are with marking capability, and may embed a mark into a signature packet (details of the “signature packet” is described below with reference to FIG. 6) if there is a need to trace the routing path. Each packet originates from a source (S) 104, travels through multiple routers belonging to different ISPs (e.g., ISPs 110, 112, 114), and finally reaches a destination (D) 106.

The objective of the disclosure is to provide a privacy preserving traceback solution for the entire routing path, i.e., each router along the path will participate in the marking process. Instead of considering per packet marking, the IP traceback solution focus on per session marking. A session may be defined as a set of packets with the same set of header information and correlated in time. The set of header information may be defined by an ISP, an example being the three-tuple of {destination IP address, destination port, protocol}. Two sessions with same header information may be separated by a time duration defined by the ISP. Without loss of generality, in the following a session identifier (ID) may be used to denote a session that is uniquely identified by the header information and start time of the session.

Group signature is a cryptographic primitive belonging to public key infrastructure (PKI). Unlike a traditional digital signature, where each signer has its own public/private key pair for signature generation and verification, in a group signature setting, a group of signers share the same public key, while each have their own private signing key. The primitive allows a member of a group to sign on a document/message in an anonymous way, such that the signature could be verified (proof that the signature is genuinely generated) by entity with the knowledge of the public key, at the same time without revealing the signer (member) identity. Only the group master who controls the group, and in possession of a master secret key, could reveal the identity of the signer (member) through a signature “opening” process, whenever there is a need.

In the context of the system architecture described above, the ISP (e.g., the IPS 110) may be the group master, and routers within its administrative control (e.g., the routers 120, 122, 124, 126) may be its group members (signers). The ISPs may share their public keys with the TA 102. Yet, besides the signing router, only the ISP (that owns/controls the signing router) may know the signing router's identity.

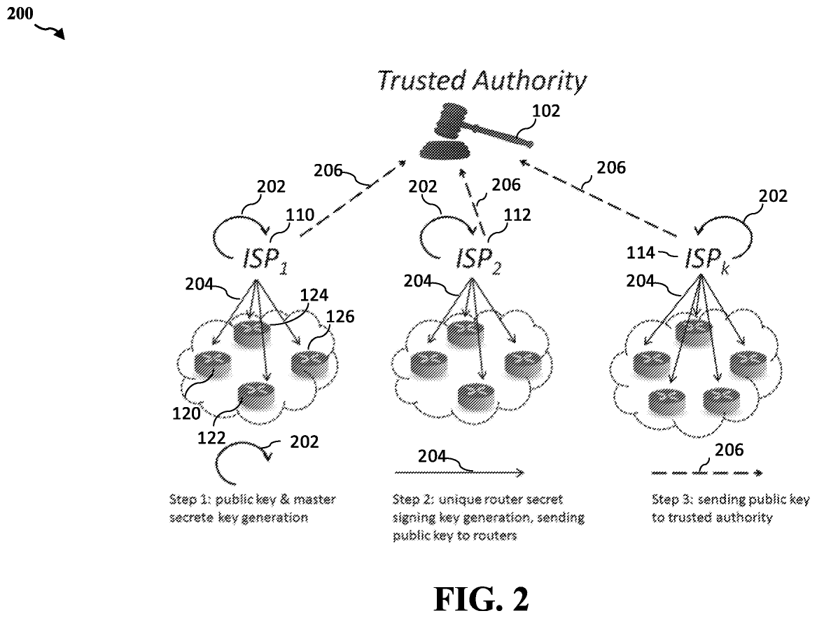

FIG. 2 is a diagram 200 illustrating an example of the setup process for the IP traceback solution described above in FIG. 1. In the example, during the system setup, each ISP (e.g., the ISP 110, 112, or 114) may generate (at 202) its own group public key and master secret key, and issue (at 204) individual and unique private signing key for each of the routers it controls. For example, the ISP 110 may generate (at 202) its own group public key and master secret key, and issue (at 204) individual and unique private signing key for each of the routers 120, 122, 124, and 126. Each ISP may also send (at 206) the group public key to the TA 102, and the TA 102 may keep this public key secret to itself (i.e., the public key is only known to the ISP, the router it controls, and the TA 102).

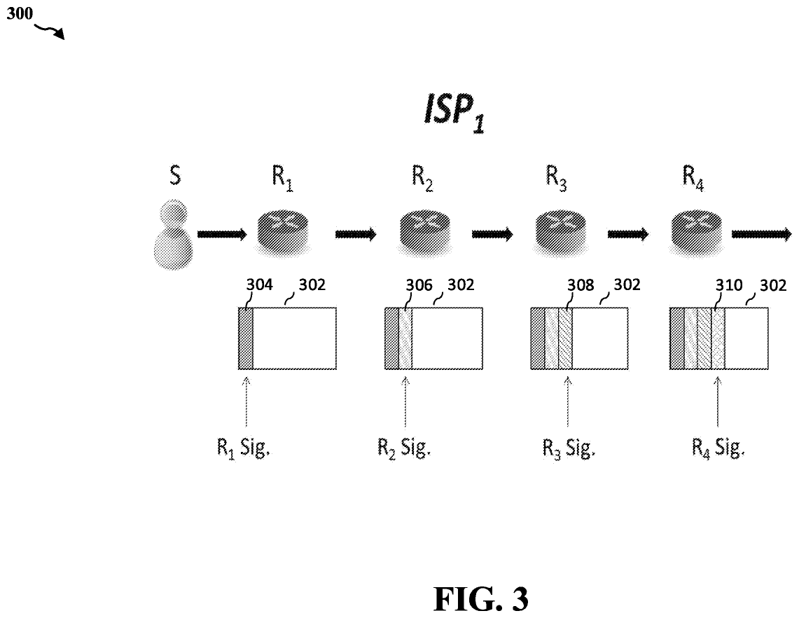

FIG. 3 is a diagram 300 illustrating an example of the marking process involved in the IP traceback solution. In the example, whenever there is a need to mark packets that pass through a specific router R, the router R may generate a group signature using its own signing key based on session specific information (e.g., session ID and timestamp as mentioned before), and append the signature to the signature packet 302 (details of such a packet is given below). Multiple routers may generate and append their signatures independently. The marking generation within the first ISP is shown in the example. For example, the router R₁ may first create the signature packet 302, and insert its generated signature 304 into the signature packet 302. Subsequent routers (e.g., R₂, R₃, R₄) may directly embed their signatures (e.g., signatures 306, 308, 310, respectively) into the signature packet 302.

When the destination receives the marking packets and wishes to find out the marking routers or routing path, the destination may present the signature to the TA. The TA may first segregate the signatures into individual ones. The TA may then use the public keys of each ISP to verify the signatures. Whenever signature verification is successful, the TA may be able to identify the ISP by the corresponding public key used for the successful verification. This essentially means that, one of the routers of the identified ISP has produced the mark (generated the signature). Therefore, the TA may pass this respective signature to the corresponding ISP for further tracing. In one embodiment, the trusted authority may only trace down to the ISP level, and in particular, cannot identify the router that actually signed the signature due to the anonymous property of group signature.

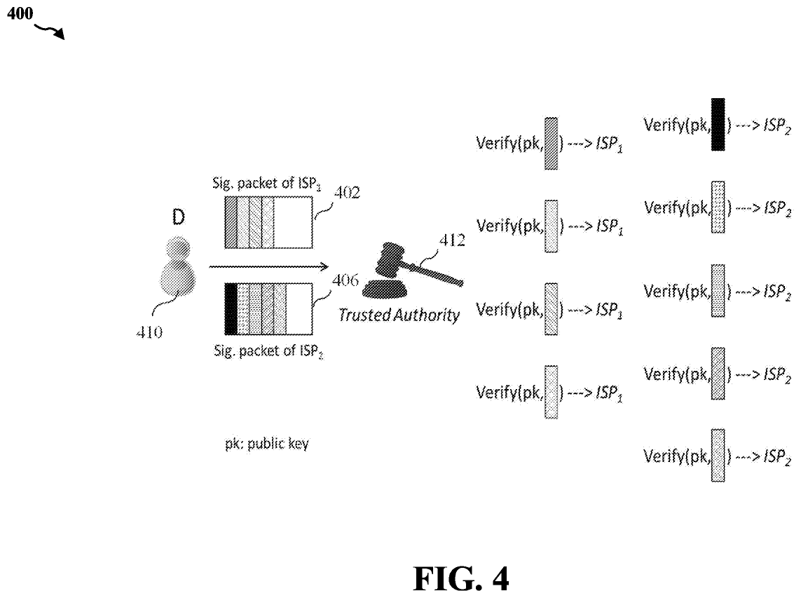

FIG. 4 is a diagram 400 illustrating an example of the overall process for a trusted authority to verify signatures and identify a corresponding ISP. In the example, the destination 410 presents two signature packets 402 and 406 (from ISP₁ and ISP₂, respectively) to the TA 412. The TA 412 may verify each signature and identify the respective ISP. In one embodiment, the TA 412 may only verify the first signature of each signature packet, and then identify the corresponding ISP (as all the remaining signatures in the same packet are generated by the routers belong to the same ISP). In another embodiment, the TA 412 may verify each individual signature of a signature packet, to confirm they are well formed.

Each ISP, receiving the signature packet produced by its routers, may use the associated public key and master secret key to “open” the signatures (i.e., trace the signer of the particular signature). This way, the ISP may identify the marking routers and routing path, and subsequently (if needed) deploy preventive or mitigate action on the marking routers.

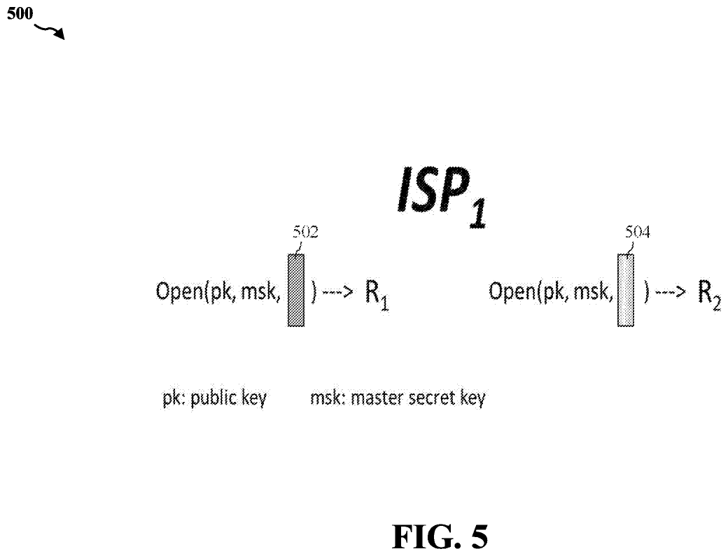

FIG. 5 is a diagram 500 illustrating an example of the tracing operation performed by an ISP. In the example, the ISP₁ may receive signatures 502 and 504 that are produced by its routers. The signatures 502 and 504 may be within a signature packet produced by routers of the ISP₁. The ISP₁ may use its public key and master secret key to open the signatures 502 and 504, and identify routers R₁ and R₂ as the routers that signed the signatures 502 and 504, respectively.

In one embodiment, the group signature may be used for providing privacy preserving IP traceback. The group signature may utilize the elliptic curve cryptography, where the signature (used as packet mark) is presented in binary bit strings. The signature size, depending on the respective underlying construction used as well as the security level needed to be maintained, is usually between thousand to two thousands bits. For example, a classical group signature construction may have signature size of 1533 bits (192 bytes), and another group signature construction may have signature length of 1363 bits (171 bytes). Both constructions have security strength similar to a 1024-bit RSA digital signature. Such a security level may be sufficient for traceback application, where the secret (e.g., the path information) usually does not necessarily need to be protected for years.

However, it may be challenging to embed such a signature directly into the transiting packets, as there is limited free space in the packet header. To overcome this challenge, in one embodiment, a new packet may be generated for carrying signatures of an ISP. That is, one new packet may be generated for each session by an ISP. The first router, the ingress router in the ISP that produces the first mark in an ISP, may create this additional packet, which may be referred to as a signature packet. A signature packet may be generated for each network session. This packet may be used to store and transmit the signatures generated by the all routers in the path taken by the session within the same ISP. Assuming a maximum packet size of around 1500 bytes, each created packet may accommodate up to (at least) 7 signatures. This effectively means that a single packet created could support identification of an ISP path consisting seven different routers.

FIG. 6 is a diagram illustrating an example of the format of a signature packet 600. The signature packet 600 may include a packet header 602, session-specific information (SSI) field 604, signature length field 606, as well as the actual signature field 608 for storing the generated signatures.

The packet header 602 may contain the same destination IP address as the traffic in this particular session. In one embodiment, a specific destination port may be defined to identify the signature packet 600 (e.g., a port number >1024). The source IP address and port could be arbitrary values.

Each group signature may be generated based on the SSI, and this information may be later used for signature verification. The SSI may be a hash of session ID and session timestamp. This length of the SSI field 604 may be 32 bits, sufficient to uniquely identify around 4.2 billion sessions with respect to a destination.

The signature length field 606 may be used to segregate the concatenated signatures during the traceback procedure. The TA and ISP, with this information, may easily segregate the signatures produced by different routers. The signature length value could be different, according to the different group signature construction as well as the security level adapted by different ISPs, as discussed above (e.g., two groups signature constructions may have roughly the same security level, but differs on signature length by 170 bits).

Public key cryptosystem (e.g., group signature) may be much slower than the symmetric key cryptosystem. To overcome this constraint, in one embodiment, most of the signature generation process may be carried out offline (i.e., before the packet arrives), when the router is free or less occupied. The routers may pre-process heavy computational tasks such as cryptographic pairing (a particular type of mathematical computation), and save dozens to hundreds of milliseconds of signature generation time. The real-time computation to complete the generation of the partial (pre-processed) signature may involve relatively few operations (e.g., one hash operation, five multiplications, and five additions). The computational time for multiplication and addition are negligible, while for hash operation it may take roughly 20 cycles per byte processing. This speed would incur only a minimum delay for packet processing.

In one embodiment, for the pre-processing, the router may needs to generate a few random numbers, and subsequently use these random numbers to pre-compute partial group signatures, and store this information. A router may, for example, pre-compute 10 of such partial group signatures, and store them as a stack or other suitable data structure. Whenever there is a need to produce a full group signature, the router may pop one set of values and perform the remaining fast and simple operations (e.g., hash, multiplication and addition operation). The router may replenish the stack with partial signatures, whenever it is free or less busy. Furthermore, the pre-computation of partial signature does not require session-specific information.

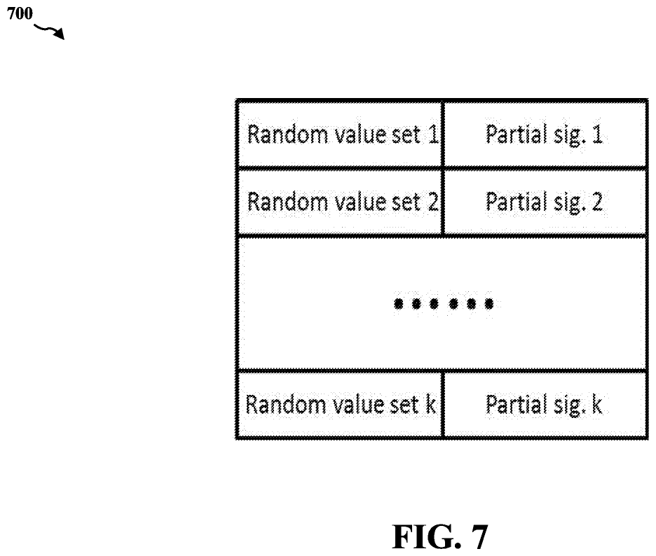

FIG. 7 is a diagram 700 illustrating an example of the storage for the pre-computed values. In the example, k random numbers are generated and k corresponding partial group signatures are computed. The random numbers and their corresponding partial group signatures are stored in the storage to expedite the generation of the full group signatures.

In one embodiment, privacy preserving marking and tracing is achieved by the IP traceback solution. In such an embodiment, the signing router produces a signature based on the commonly agreed packet information. This signature, although can be verified in conjunction with the corresponding public key by the trusted authority, would not reveal the router identity unless with the help of the master secret key, which is controlled by the ISP. Therefore, the path and topology information of an ISP may be kept confidential in the process of traceback.

In one embodiment, deterministic tracking is achieved by the IP traceback solution. In such an embodiment, during the tracing of the signing router, the ISP may perform mathematical calculations, involving the signature, public key, as well as the master secret key. This calculation may uniquely identify the router, without any false positive. Besides, the TA may identify the ISPs involved in the marking.

In one embodiment, non-repudiation is achieved by the IP traceback solution. In such an embodiment, when the signature is presented, opened, and signer identity revealed, the signer (e.g., the marking router) as well as its controlling ISP cannot deny that the particular router generated the signature.

In one embodiment, robustness is achieved by the IP traceback solution. In such embodiment, the group signature property may guarantee that, no one could generate or forge a valid signature that attributes to an innocent entity, without having the respective secret signing key of that entity.

In one embodiment, a one-time, constant size communication may be needed between the ISP and each router, as well as ISP and TA, during the system setup phase. In one embodiment, no communication between the router and ISP may be needed during the marking process. In such an embodiment, the router may independently generate the group signature with the given secret signing key. This saves communication cost and avoids system delay. In one embodiment, during the tracing process, a one-time, constant size communication may be needed from the TA to the ISP (for transmitting the signatures). In one embodiment, no communication between ISP and router may be needed for tracing.

Some embodiments of the IP traceback solution may utilize a cryptography technique, called group signature, to achieve secure, privacy preserving, and deterministic traceback, by letting the marking router to produce an anonymous signature that could only be revealed by its controlling ISP. Some embodiments of the IP traceback solution, although involves a TA, may limit the capability of the TA by preventing it from learning the router identity and thus specific ISP topology. This is a desired property for all ISPs. In some embodiments, the router may perform most of the marking computations (i.e., pre-computations) in advance during idle time, such that the actual marking time could be greatly reduced and resulting in minimum system delay.

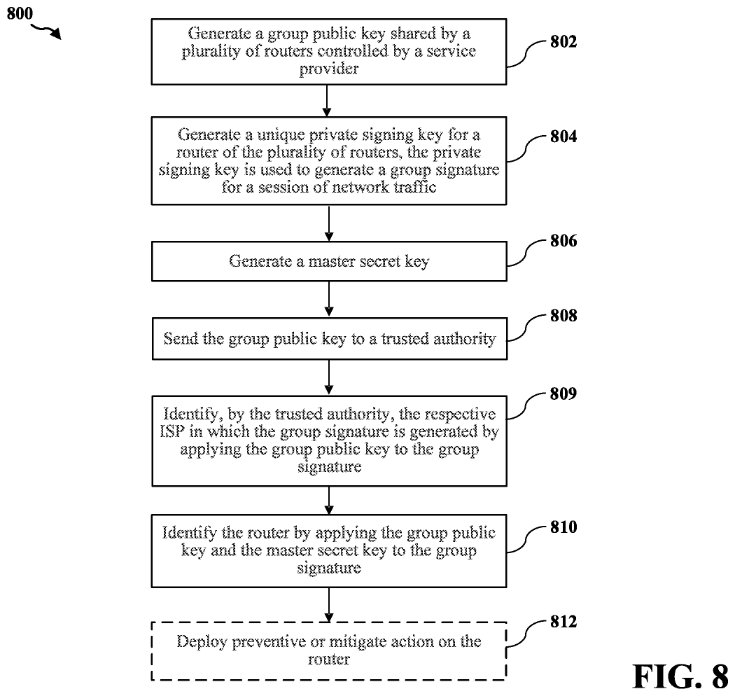

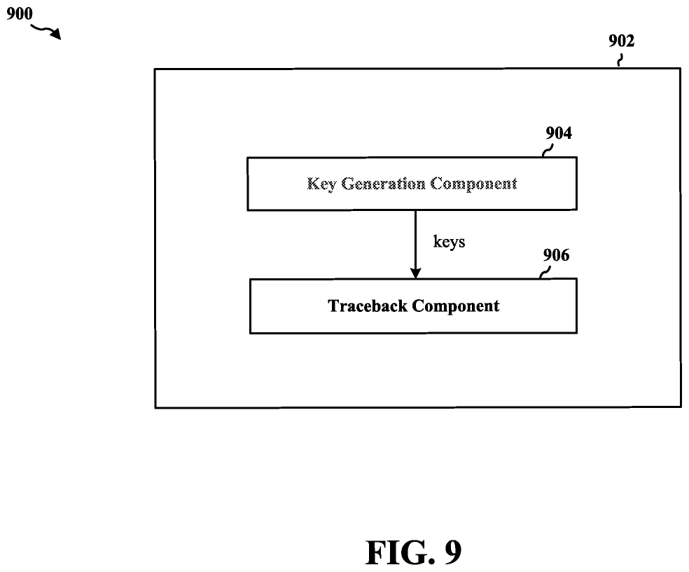

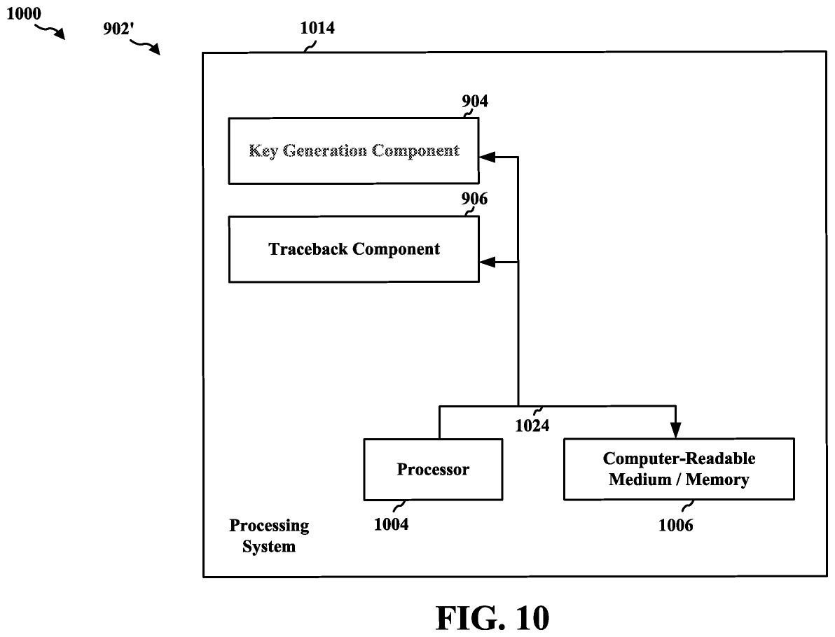

FIG. 8 is a flowchart 800 of a method of IP traceback. In one embodiment, the method may be performed by an ISP. In one embodiment, the method may be performed by a computing device or system (e.g., the apparatus 902/902′ shown in FIG. 9/FIG. 10). At 802, the apparatus may generate a group public key shared by a plurality of routers controlled by a service provider (e.g., an ISP).

At 804, the apparatus may generate a unique private signing key for a router of the plurality of routers. The private signing key may be used to generate a group signature for a session of network traffic. In one embodiment, the group public key may be applied to the group signature to identify the service provider. In one embodiment, each router of the plurality of routers may have its own private signing key.

In one embodiment, the session of network traffic may include a set of packets with the same set of header information and the set of packets may be correlated in time. In one embodiment, the set of header information may include a destination IP address, a destination port, and a protocol.

In one embodiment, the group signature may be generated based on session specific information of the session of network traffic. In one embodiment, the session specific information may include a session identifier and a timestarnp.

In one embodiment, the group signature may be appended to a signature packet. The signature packet may include a plurality of group signatures generated by a subset of the plurality of routers. In one embodiment, the group signature may be partially generated before the session of network traffic arrives at the router.

At 806, the apparatus may generate a master secret key.

At 808, the apparatus may send the group public key to a trusted authority. In one embodiment, the master secret key may be prohibited from being sent to the trusted authority.

At 809, the trusted authority may identify the respective ISP in which the group signature is generated by applying the group public key to the group signature. In some embodiments, the trusted authority may further notify the identified ISP about the finding.

At 810, the apparatus may identify the router by applying the group public key and the master secret key to the group signature. In one embodiment, the apparatus may use the group public key and the master secret key to open the group signature, thus identifying the router.

At 812, the apparatus may optionally deploy preventive or mitigate action on the identified router. For example, the apparatus may block network traffic originated from the identified router, or rate limit the identified router.

FIG. 9 is a conceptual data flow diagram 900 illustrating the data flow between different means/components in an exemplary apparatus 902. The apparatus 902 may be a computing device or a system including multiple computing devices.

The apparatus 902 may include a key generation component 904 that generates the group public key, the private signing keys, and the master secret key. In one embodiment, the key generation component 904 may perform the operations described above with reference to 802, 804, or 806 in FIG. 8.

The apparatus 902 may include a traceback component 906 that performs IP traceback using the keys generated by the key generation component 904. In one embodiment, the traceback component 906 may perform the operations described above with reference to 810 in FIG. 8.

The apparatus 902 may include additional components that perform each of the blocks of the algorithm in the aforementioned flowchart of FIG. 8. As such, each block in the aforementioned flowchart of FIG. 8 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

FIG. 10 is a diagram 1000 illustrating an example of a hardware implementation for an apparatus 902′ employing a processing system 1014. The apparatus 902′ may be the apparatus 902 described above with reference to FIG. 9. The processing system 1014 may be implemented with a bus architecture, represented generally by the bus 1024. The bus 1024 may include any number of interconnecting buses and bridges depending on the specific application of the processing system 1014 and the overall design constraints. The bus 1024 links together various circuits including one or more processors and/or hardware components, represented by the processor 1004, the components 904, 906, and the computer-readable medium/memory 1006. The bus 1024 may also link various other circuits such as timing sources, peripherals, voltage regulators, and power management circuits, which are well known in the art, and therefore, will not be described any further.

The processing system 1014 includes a processor 1004 coupled to a computer-readable medium/memory 1006. The processor 1004 is responsible for general processing, including the execution of software stored on the computer-readable medium/memory 1006. The software, when executed by the processor 1004, causes the processing system 1014 to perform the various functions described supra for any particular apparatus. The computer-readable medium/memory 1006 may also be used for storing data that is manipulated by the processor 1004 when executing software. The processing system 1014 further includes at least one of the components 904, 906. The components may be software components running in the processor 1004, resident/stored in the computer readable medium/memory 1006, one or more hardware components coupled to the processor 1004, or some combination thereof.

In the following, various aspects of this disclosure will be illustrated:

Example 1 is a method or apparatus for IP traceback. The apparatus may generate a group public key shared by a plurality of routers controlled by a service provider. The apparatus may generate a unique private signing key for a router of the plurality of routers. The private signing key may be used to generate a group signature for a session of network traffic. The group public key may be applied to the group signature to identify the service provider. The apparatus may identify the router by applying the group public key and a master secret key to the group signature.

In Example 2, the subject matter of Example 1 may optionally include that the session of network traffic may include a set of packets with a same set of header information and the set of packets may be correlated in time.

In Example 3, the subject matter Example 2 may optionally include that the set of header information may include a destination IP address, a destination port, and a protocol.

In Example 4, the subject matter of any one of Examples 1 to 3 may optionally include that each router of the plurality of routers may have its own private signing key.

In Example 5, the subject matter of any one of Examples 1 to 4 may optionally include that the apparatus may further send the group public key to a trusted authority.

In Example 6, the subject matter of any one of Examples 1 to 5 may optionally include that the master secret key may be prohibited from being sent to the trusted authority.

In Example 7, the subject matter of any one of Examples 1 to 6 may optionally include that the apparatus may further generate the master secret key.

In Example 8, the subject matter of any one of Examples 1 to 7 may optionally include that the group signature may be generated based on session specific information of the session of network traffic.

In Example 9, the subject matter of Example 8 may optionally include that the session specific information may include a session identifier and a timestamp.

In Example 10, the subject matter of any one of Examples 1 to 9 may optionally include that the group signature may be appended to a signature packet, where the signature packet may include a plurality of group signatures generated by a subset of the plurality of routers.

In Example 11, the subject matter of any one of Examples 1 to 10 may optionally include that the apparatus may deploy preventive or mitigate action on the router.

In Example 12, the subject matter of any one of Examples 1 to 11 may optionally include that the group signature may be partially generated before the session of network traffic arrives at the router.

A person skilled in the art will appreciate that the terminology used herein is for the purpose of describing various embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of IP traceback, comprising:
generating a group public key shared by a plurality of routers controlled by a service provider;
generating a unique private signing key for a router of the plurality of routers, wherein the private signing key is used to generate a group signature for a session of network traffic, wherein the group public key is applied to the group signature to identify the service provider; and
identifying the router by applying the group public key and a master secret key to the group signature.

2. The method of claim 1, wherein the session of network traffic comprises a set of packets with a same set of header information and the set of packets are correlated in time, wherein the set of header information comprises a destination IP address, a destination port, and a protocol.

3. The method of claim 1, further comprising sending the group public key to a trusted authority, wherein the master secret key is prohibited from being sent to the trusted authority.

4. The method of claim 1, further comprising generating the master secret key.

5. The method of claim 1, wherein the group signature is generated based on session specific information of the session of network traffic.

6. The method of claim 5, wherein the session specific information comprises a session identifier and a timestamp.

7. The method of claim 1, wherein the group signature is appended to a signature packet, wherein the signature packet comprises a plurality of group signatures generated by a subset of the plurality of routers.

8. The method of claim 1, further comprising deploying preventive or mitigate action on the router.

9. The method of claim 1, wherein the group signature is partially generated before the session of network traffic arrives at the router.

10. An apparatus for IP traceback, comprising:
a memory; and
at least one processor coupled to the memory and configured to:
generate a group public key shared by a plurality of routers controlled by a service provider;
generate a unique private signing key for a router of the plurality of routers, wherein the private signing key is used to generate a group signature for a session of network traffic, wherein the group public key is applied to the group signature to identify the service provider; and
identify the router by applying the group public key and a master secret key to the group signature.

11. The apparatus of claim 10, wherein the session of network traffic comprises a set of packets with a same set of header information and the set of packets are correlated in time, wherein the set of header information comprises a destination IP address, a destination port, and a protocol.

12. The apparatus of claim 10, wherein the at least one processor is further configured to send the group public key to a trusted authority, wherein the master secret key is prohibited from being sent to the trusted authority.

13. The apparatus of claim 10, wherein the at least one processor is further configured to generate the master secret key.

14. The apparatus of claim 10, wherein the group signature is generated based on session specific information of the session of network traffic.

15. The apparatus of claim 14, wherein the session specific information comprises a session identifier and a timestamp.

16. The apparatus of claim 10, wherein the group signature is appended to a signature packet, wherein the signature packet comprises a plurality of group signatures generated by a subset of the plurality of routers.

17. The apparatus of claim 10, wherein the at least one processor is further configured to deploy preventive or mitigate action on the router.

18. The apparatus of claim 10, wherein the group signature is partially generated before the session of network traffic arrives at the router.

19. A computer-readable medium storing computer executable code, comprising instructions for:
generating a group public key shared by a plurality of routers controlled by a service provider;
generating a unique private signing key for a router of the plurality of routers, wherein the private signing key is used to generate a group signature for a session of network traffic, wherein the group public key is applied to the group signature to identify the service provider; and
identifying the router by applying the group public key and a master secret key to the group signature.

20. The computer-readable medium of claim 19, further comprising instructions for deploying preventive or mitigate action on the router.
